(19) United States
(12) Patent Application Publication
(10) Pub. No.: US 2008/0259769 A1
(43) Pub. Date: Oct. 23, 2008

(54) Method for Improving the Playability of Non-Ideal Optical Carriers

(75) Inventors: Yu Zhou, Singapore (SG); Kia Suan Tan, Singapore (SG)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 12/065,627

(22) PCT Filed: Aug. 30, 2006
(86) PCT No.: PCT/IB06/53006

§ 371 Date: Mar. 4, 2008

(30) Foreign Application Priority Data
Sep. 9, 2005 (EP) 05108292.3

(51) Int. Cl. G11B 7/00

(52) U.S. Cl. 369/112.22

(57) ABSTRACT

The present invention relates to a method for improving the playability of non-ideal optical disks. Initially, an asymmetry (AsI) of the optical carrier is determined. If the asymmetry is above a pre-defined first threshold then a step of decreasing an upper cut-off frequency (HPF) to a first cut-off frequency (HPF1) of a high pass filtering (BPF) performed on a data channel (HF) in response to the asymmetry (AsI) is undertaken. Subsequently, a step of optimizing an amplification level of a radial error signal (RE) and/or a focus error signal (FE) of a servomechanism controlling the optical carrier is undertaken. Finally, a last step of determining a second indication of asymmetry (As2) of the data channel (HF) from the optical carrier is performed. The invention is advantageous because a better indication of the asymmetry is provided because the asymmetry is assessed two consecutive times interrupted by a high pass filter adjustment.

The present invention relates to a method for improving the playability of non-ideal optical carriers when reproducing information from an optical carrier in an optical drive. The invention also relates to a corresponding optical drive.

Within the field of optical storage of information on optical carriers such as CDs, DVDs, BDs, etc. there are well established standards for the maximal physical tolerances and characteristics of the readout high frequency signal (HF) of the optical carriers that are meant to be followed by the producers of the optical carriers or disks. These standards are known from the so-called Red Book and Yellow Book for the CD standard and the standards from the so-called Book A, Book B, Book C etc. for the DVD disks. Compliance with these standards enables playability between carriers and optical drives of various origins despite the deviations from e.g. one carrier to another. Playability may accordingly be defined as the ability to reproduce information from non-ideal carriers in non-ideal circumstances.

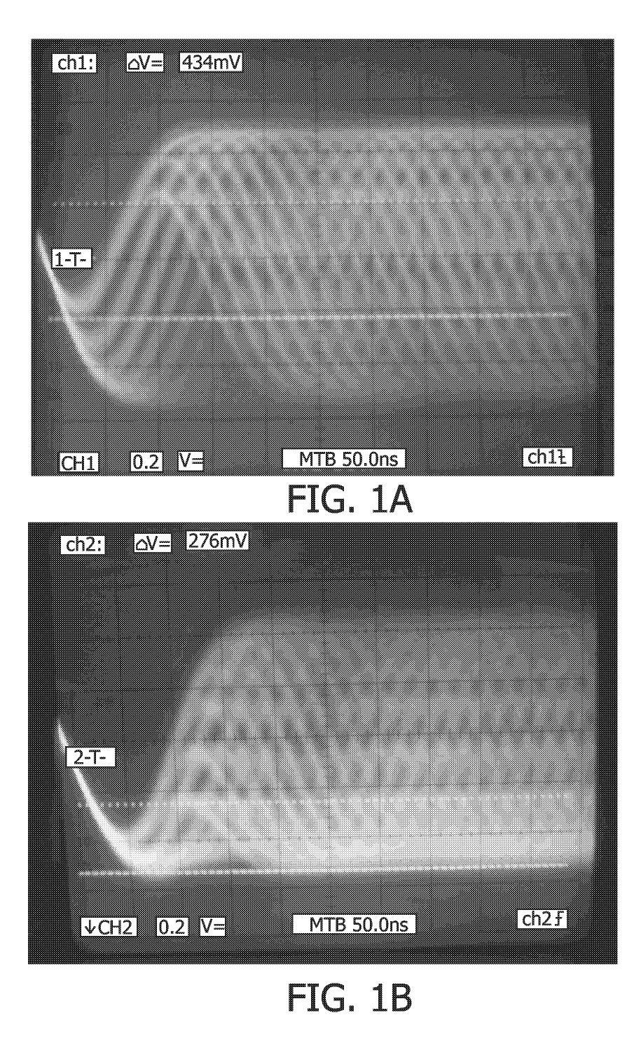

One such deviation from ideal is the asymmetry (As) of the HF signal. This may result from a non-perfect manufacturing of a read-only disc such as a DVD-ROM. In FIG. 1A an example of the well-known eye pattern is shown for a normal disc. For comparison, an eye pattern from a disk suffering from a highly asymmetric HF signal is shown in FIG. 1B. The horizontal, dotted lines show the levels of the 3T component of the HF signal. It is seen that the 3T signal is shifted far below the center of the HF signal for the asymmetric disc of FIG. 1B. For all the discs the asymmetry (As) by the read-only pickup should be, as preferred by the standards,

As=|A1−A2|/|A1+A2|<0.2,

where A1 and A2, respectively, are peak values in opposite directions relative to the average value of the HF signal. Benchmark results undertaken by the present applicant indicate that about of 5% of all DVD-ROM carriers have an asymmetry above normal. Similarly, recording of information performed on writeable discs often results in an asymmetry of the HF signal that is above normal. Possibly 20-30% of all writeable DVDs suffer from this defect.

The asymmetry problem of non-ideal disks has been solved in various ways. In e.g. US patent application US 2004/0042366 the slice level of the HF slicer is adjusted in response to the asymmetry in order to optimize the bit error rate (BER).

Nevertheless, the most common approach has hitherto been to perform a radial offset calibration so as to improve the asymmetry disc readability. This calibration is done on the “bad” HF signal quality due to disc asymmetry. This will in turn influence the calibration reliability. Secondly, the radial offset introduced by this not so reliable calibration will cause difficulties for tracking and seeking operations of the optical drive. This is unacceptable under practical operations. Finally, this radial offset calibration will also introduce an additional 0.6-1.0 seconds calibration time to the optical drive start up time.

Hence, a method for improving the playability of non-ideal optical carriers would be advantageous, and in particular a more efficient and/or reliable method for compensating the asymmetric readout signal from optical carriers would be advantageous.

Accordingly, the invention preferably seeks to mitigate, alleviate or eliminate one or more of the above mentioned disadvantages singly or in any combination. In particular, it may be seen as an object of the present invention to provide a method that solves the above-mentioned problems of the prior art with asymmetric high frequency (HF) signal from an optical carrier.

This object and several other objects are obtained in a first aspect of the invention by providing a method for improving the playability of information from a non-ideal optical carrier during readout of information from the optical carrier, the method comprising the steps of:

a. determining a first indication of asymmetry (As1) of a data channel (HF) of the information from the optical carrier,

if said first indication of asymmetry is above a pre-defined first threshold then

b. decreasing an upper cut-off frequency (HPF) to a first cut-off frequency (HPF1) of a high pass filtering performed on the data channel (HF) of the information on the carrier in response to said first indication of asymmetry (As1),
c. optimizing an amplification level of a radial error signal (RE) and/or a focus error signal (FE) of a servomechanism controlling the optical carrier, and
d. determining a second indication of asymmetry (As2) of the data channel (HF) from the optical carrier.

The invention is particularly but not exclusively advantageous for obtaining a better indication of the asymmetry because the asymmetry is assessed two consecutive times interrupted by a high pass filter adjustment and optimization of the amplification level of a radial error signal (RE) and/or a focus error signal (FE) of a servomechanism controlling the optical carrier. The present inventors have thereby obtained a more accurate assessment of the asymmetry (As). Hitherto, the applied settings of such high pass filter adjustments have not been adjusted in response to asymmetry. Omitting this adjustment will possibly result in an initial measured asymmetry being lower than the actual value, which may of course have a critical impact of the playability of the carrier in question. Previously, adjustments of the high pass filter cut-off frequency of the data channel have also been made e.g. in response to changes in a data channel bit frequency, as a radiation spot on the carrier travels from an inner position of the carrier to an outer position of the carrier for a carrier rotated under constant angular velocity (CAV). Thus, the present invention distinguishes itself from the prior art inter alia by the cut-off frequency being adjusted in response to the first initial asymmetry (As1) indication.

Secondly, the step b of decreasing a cut-off frequency (HPF1) of a high pass filtering performed on the data channel (HF) of the information on the carrier in response to said first indication of asymmetry may under some conditions improve the HF signal, i.e. by lowering the asymmetry (As).

In a first embodiment, an additional step of decreasing the cut-off frequency to a second cut-off frequency (HPF2) of the high pass filtering may be performed on the data channel (HF) of the information on the carrier if said second indication of asymmetry (As2) is above a pre-defined second threshold. Similarly, a step of increasing a lower cut-off frequency (LPF1) of a low pass filtering may be performed on the data channel (HF) of the information on the carrier if said second indication of asymmetry (As2) is above a pre-defined second threshold. Preferably, the upper and lower frequency settings are set to give the smallest asymmetry (As). More preferably, an optimization procedure for the asymmetry (As2) is undertaken.

In another embodiment, a step of determination of a third indication of asymmetry (As3) of the data channel (HF) from the optical carrier may be implemented, and there may be applied an equalizer for amplifying a data channel portion comprising a relatively low integer of channel bits in a channel code, e.g. EFM+, of the data channel (HF) in response to said third indication of asymmetry (As3). Thus, high frequency components, e.g. 3T, 4T, 5T etc, are boosted.

Advantageously, in yet another embodiment of the invention there may be performed an optimization of the data channel jitter by variation of one or more adjustable parameters of the equalizer resulting in an improved signal. Alternatively, the bit error rate (BER) may be minimized under variation of the one or more adjustable parameters of the equalizer also resulting in an improved signal.

Beneficially, the step c) of optimizing an amplification level of a radial error signal (RE) and/or a focus error signal (FE) of a servomechanism controlling the optical carrier may be performed by application of automatic gain control (ATC) or other similar measures.

To improve the results obtained by the present invention one or more of the steps a, b, c, and d may be repeated a plurality of times, e.g. various averaging procedures may be implemented.

In a second aspect, the invention relates to an optical drive for recording/reproducing information from a non-ideal optical carrier, said optical drive being adapted to improve the playability during readout of information from the optical carrier, the optical drive comprising:

a. measurement means adapted for determining a second indication of asymmetry of the data channel from the optical carrier.
b. high pass filtering means for decreasing an upper cut-off frequency (HPF) to a first cut-off frequency (HPF1) of the data channel (HF) of the information on the carrier in response to said first indication of asymmetry (As1) if said first indication of asymmetry is above a pre-defined first threshold, and
c. amplification means for optimizing an amplification level of a radial error signal (RE) and/or a focus error signal (FE) of a servomechanism controlling the optical carrier, and
d. measurement means adapted for determining a second indication of asymmetry (As2) of the data channel (HF) from the optical carrier.

In a third aspect, the invention relates to a computer program being adapted to enable a computer system comprising at least one computer having data storage means associated therewith to improve the playability of information from a non-ideal optical carrier during readout of information according to the first aspect of the invention.

This aspect of the invention is particularly, but not exclusively, advantageous in that the present invention may be implemented by a computer program product enabling a computer system to perform the operations of the first aspect of the invention. Thus, it is contemplated that some known optical recording/reproduction apparatus may be changed to operate according to the present invention by installing a computer program product on a computer system controlling the said optical recording/reproduction apparatus. Such a computer program product may be provided on any kind of computer readable medium, e.g. a magnetically or optically based medium, or through a computer based network, e.g. the Internet.

The first, second and third aspect of the present invention may each be combined with any of the other aspects. These and other aspects of the invention will be apparent from and elucidated with reference to the embodiments described hereinafter.

The present invention will now be explained, by way of example only, with reference to the accompanying Figures, where

FIG. 1 illustrates two HF signal portions from the so-called eye pattern; FIG. 1A with a near-ideal symmetric signal and FIG. 1B with a highly asymmetric signal,

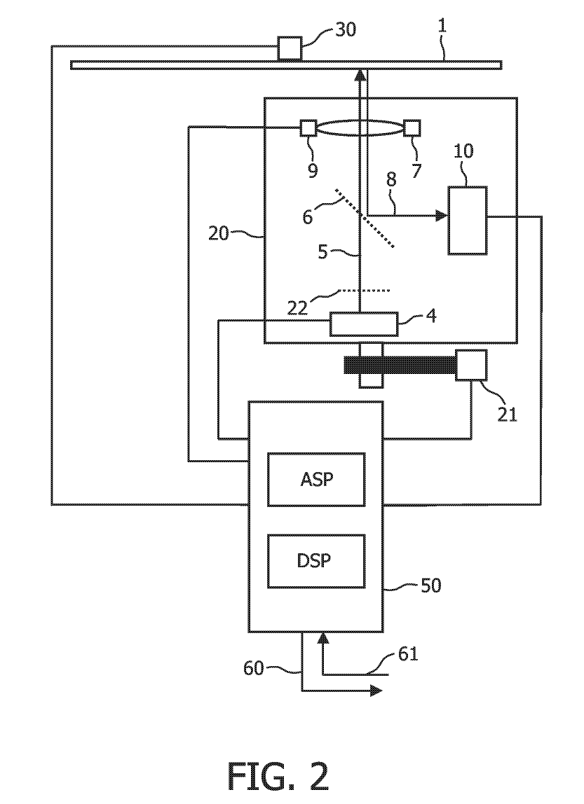

FIG. 2 is a schematic block diagram of an embodiment of an optical recording/reproducing apparatus according to the invention,

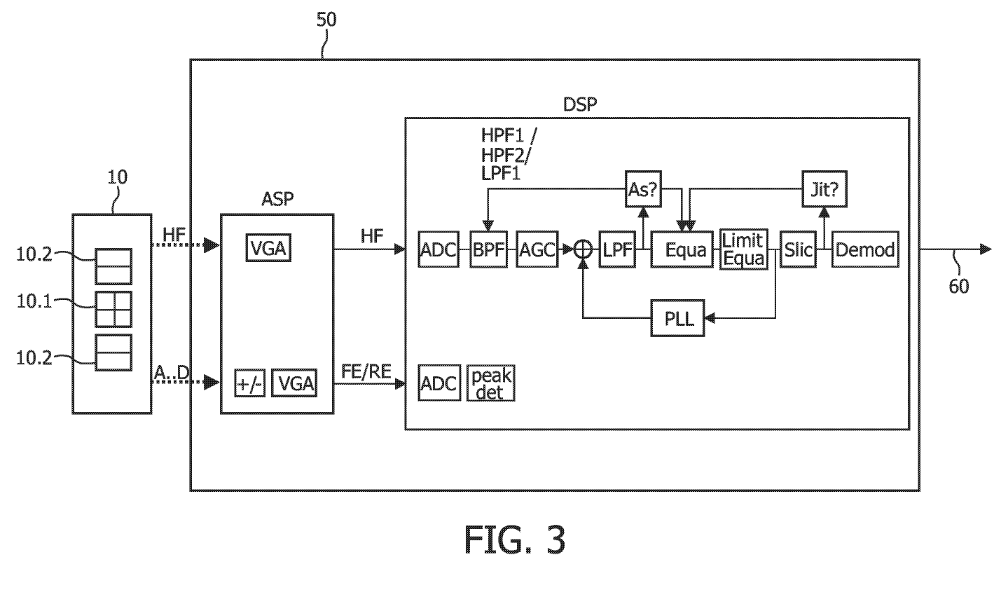

FIG. 3 is a schematic block diagram of an embodiment of a digital signal processor according to the present invention,

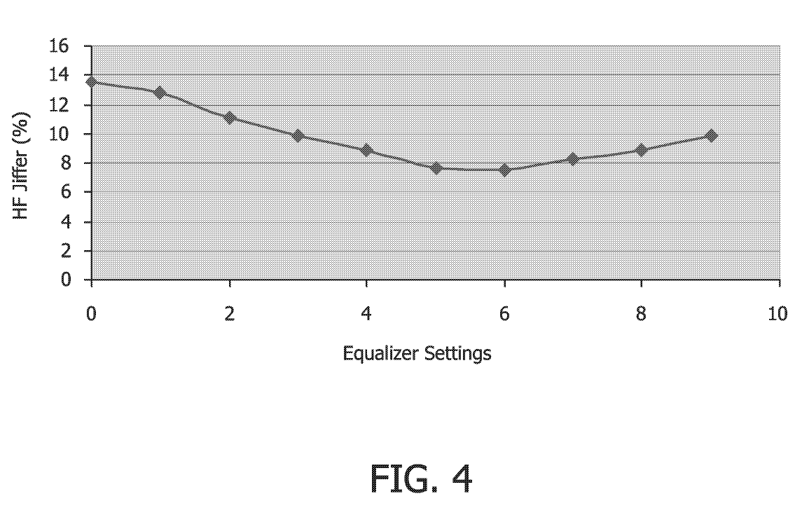

FIG. 4 shows experimental results of varying the equalizer settings and the resulting HF jitter, and

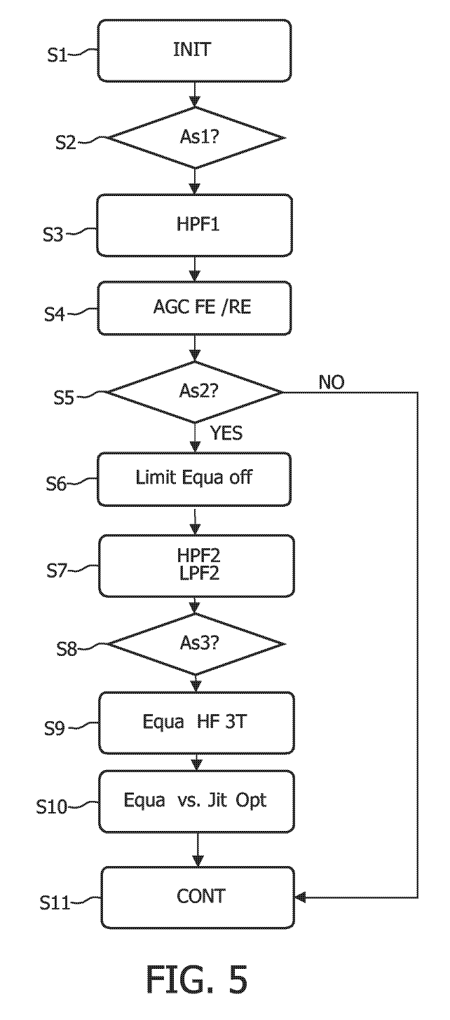

FIG. 5 is a flow-chart of a method according to the invention.

In FIG. 1, two eye patterns are shown. In FIG. 1A, the eye pattern is shown for a normal disc. In FIG. 1B, an eye pattern from a disk suffering from a highly asymmetric HF signal is shown. The dotted lines show the levels of the 3T component of the HF signal. It is seen that the 3T signal is shifted far below the center of the HF signal for the asymmetric disc of FIG. 1B.

FIG. 2 shows an optical apparatus or drive and an optical information carrier 1 according to the invention. The carrier 1 is fixed and rotated by holding means 30.

The carrier 1 comprises a material suitable for recording information by means of a radiation beam 5. The recording material may be of, for example, the magneto-optical type, the phase-change type, the dye type, metal alloys like Cu/Si or any other suitable material. Information may be recorded in the form of optically detectable regions, also called marks for rewriteable media and pits for write-once media, on the carrier 1.

The apparatus comprises an optical head 20, sometimes called an optical pick-up (OPU), the optical head 20 being displaceable by actuation means 21, e.g. an electric stepping motor. The optical head 20 comprises a photo detection system 10, a radiation source 4, a beam splitter 6, an objective lens 7, and lens displacement means 9 capable of displacing the lens 7 both in a radial direction of the carrier 1 and in the focus direction. The optical head 20 may also comprise beam splitting means 22, such as a grating or a holographic pattern that is capable of splitting the radiation beam 5 into at least three components for use in the three spot differential push-pull radial tracking, or any other applicable control method. For clarity reason, the radiation beam 5 is shown as a single beam after passing through the beam splitting means 22. Similarly, the radiation 8 reflected may also comprise more than one component, e.g. the three spots and diffractions thereof, but only one beam 8 is shown in FIG. 2 for clarity.

The function of the photo detection system 10 is to convert radiation 8 reflected from the carrier 1 into electrical signals. Thus, the photo detection system 10 comprises several photo detectors, e.g. photodiodes, charge-coupled devices (CCD), etc., capable of generating one or more electric output signals that may be defined as first signals with the context of the present invention. The photo detectors are arranged spatially to one another, and with a sufficient time resolution so as to enable detection of error signals, i.e. focus FE and radial tracking RE. The focus FE and radial tracking error RE signals are transmitted to the processor 50 where commonly known servomechanism operated by usage of PID control means (proportional-integrate-differentiate) is applied for controlling the radial position and focus position of the radiation beam 5 on the carrier 1.

The photo detection system 10 can also output a read signal or HF signal representing the information being read from the carrier 1 to the processor 50. The read signal may possibly be converted to a central aperture (CA) signal by a low-pass filtering of the HF signal in the processor 50.

The radiation source 4 for emitting a radiation beam or a light beam 5 can for example be a semiconductor laser with a variable power, possibly also with variable wavelength of radiation. Alternatively, the radiation source 4 may comprise more than one laser. In the context of the present invention, the term “light” is considered to comprise any kind of electromagnetic radiation suitable for optical recording and/or reproduction, such as visible light, ultraviolet light (UV), infrared light (IR) etc.

The optical head 20 is optically arranged so that the radiation beam 5 is directed to the optical carrier 1 via a beam splitter 6, and an objective lens 7. Radiation 8 reflected from the carrier 1 is collected by the objective lens 7 and, after passing through the beam splitter 6, falls on a photo detection system 10 which converts the incident radiation 8 to electric output signals as described above.

The processor 50 receives and analyses signals from the photo detection means 10. The processor 50 can also output control signals to the actuation means 21, the radiation source 4, the lens displacement means 9, and the rotating means 30, as schematically illustrated in FIG. 2. Similarly, the processor 50 can receive data, indicated at 61, and the processor 50 may output data from the reading process as indicated at 60. As shown in FIG. 2, the processor 50 comprises two parts; a first processing means being an analog signal processor ASP (also called an HF processor) and a second processing means being a digital signal processor DSP.

FIG. 3 is a schematic block diagram of the processor 50 of an optical apparatus shown in FIG. 2. Additionally, the photo detection means 10 is shown to the left of the processor 50 with a schematical drawing of a central photo detector 10.1 divided into four sections for the central beam 8 and two neighboring photo detectors 10.2, each divided into two sections, for satellite beams of the central beam 8.

From the photo detection means 10 a signal, termed HF in FIG. 3, is transmitted to the processor 50. Processing of this signal through the processor 50 defines an HF channel or an HF data path as indicated in the upper part of the processor 50. Normally, the first HF signal is the sum of light intensities incident on the central detector 10.1.

From the photo detection means 10 another first signal, termed A . . . D in FIG. 3, is also transmitted to the processor 50. The A . . . D signals comprise separate components of the different photo detector sections of the photo detectors 10.1 and 10.2 for subsequent use in focus error tracking, radial error tracking, wobble signal, synchronizing with write clock, obtaining mirror signals etc. Processing of this signal trough the processor 50 defines an auxiliary channel or an auxiliary data path as indicated in the lower part of the processor 50.

In the upper channel, the HF signal is initially amplified in the variable gain amplifier VGA in the ASP of the processor 50.

The HF second signal is then transmitted to the DSP for initial analog to digital conversion in the ADC. After being converted to the digital domain, the HF signal is passed to a band pass filter BPF. The upper cut-off frequency (HPF) and the lower cut-off frequency (LPF) of the band pass filter BPF are controllable from the processing part As?, where the asymmetry As is determined. However, the BPF is also controllable in response to the channel bit frequency length, this dependency being omitted in FIG. 3 for clarity. After the band pass filtering, the signal is amplified under an automatic gain control AGC of the conventional type. The AGC will adjust the radial and focus loop bandwidth to predesigned value so that a best tracking performance can be achieved.

Following automatic gain control, a phase-lock-loop PLL for synchronizing with e.g. a writing clock for timing of writing on the carrier 1 is implemented. A phase comparator (not shown) and a low pass filter LPF are applied in closed loop with a voltage controlled oscillator (not shown) to generate a clocking signal for subsequent decoding of the HF signal.

Within the phase lock loop, there is integrated measurement means As? for determining the asymmetry (As) of the HF signal or the data channel in the upper part of the processor 50. The measurement itself of the asymmetry (As) may be performed by measurement means well known to the skilled person, see e.g. US Patent Application Publication 2004/0145987. In the context of the present application, it is to be understood that “a measurement of asymmetry” or “an indication of asymmetry” may include any measures being derived or derivable, directly or indirectly, from the asymmetry value itself. Thus, for some applications possibly only a signal proportional to the asymmetry may be necessary for implementing the present invention. From the measurement means As? a control value is transmitted to the band pass filter BPF if the asymmetry As is above a predetermined level. The first predetermined level may be 0.10, 0.15, 0.20, 0.25, 0.30, 0.35 or 0.40 etc. Alternatively, the predetermined level may be 0.13, 0.18, 0.23, 0.25, 0.30, 0.38 or 0.43, etc. Based on experiments, there is a tendency that it may be advantageous with delta difference of 0.03-0.05. The control value sent to the BPF will then decrease the upper cut-off frequency (HFP) according to the first aspect of the present invention to the first cut-off frequency HPF1. The relative decrease of the cut-off frequency HFP may be approximately 5%, 10%, 15%, 20%, 25%, 30%, 35%, 40%, 45%, 50%, 55%, 60%, 65%, 70%, or 75% depending on the carrier and the operating conditions of the optical drive in question. An example may be a DVD ROM carrier rotated at 40 Hz where the upper cut-off frequency was set to 21.6 kHz and then lowered to 13.5 kHz with significant improvement in the second determination of the asymmetry (As2). The asymmetry could be reduced to a low value like 3% also after all the adjustments and calibrations (see below). It is contemplated that the decrease of the upper cut frequency (HPF) may be adjusted, preferably decreased, a plurality of times in order to obtain a credible value of the asymmetry. Thus, the adjustment and the measurement of asymmetry may constitute a looping measurement of the asymmetry. Typically, a measurement of the asymmetry As1 or As2 will also be the result of an averaging procedure, e.g. arithmetic or geometrical, to compensate to measurement uncertainty and/or signal instability.

In a first embodiment, there is implemented a further decreasing of the cut-off frequency to a second cut-off frequency HPF2 of the high pass filtering. This is undertaken if the second indication of asymmetry (As2) is above a pre-defined second threshold. The second predetermined level may be 0.10, 0.15, 0.20, 0.25, 0.30, 0.35 or 0.40. Additionally or alternatively, there is performed an increase of a cut-off frequency LPF1 of a low pass filtering performed on the data channel HF of the information on the carrier 1. Thus, the frequency window of the band pass filter BPF is diminished. Preferably, the diminishing is performed while measuring the asymmetry enabling procedures for optimization of the asymmetry, e.g. the asymmetry should be minimum. Under certain operating conditions the optimized asymmetry does, however, not necessarily result in a global minimum of the asymmetry (As) if for some other reasons the operation of the optical drive is delimited from a certain frequency regime of the BPF. For some optical drives it may be advantageous to turn off a limit equalizer Limit Equa (with adaptive clipping level for 3T amplification) before adjusting the frequency window of the BFP to avoid distortion of the 3T component or other high frequency components of the HF signal. For example, if the measured disc asymmetry is about 27%, the additional 3T boosting gain added to this asymmetry disc is about 5 dB more in addition to a normal equalizer. For different playback speed and disc types, the frequency window may be different. It is difficult to list all the possible speeds, disk types and their corresponding frequency window, but it is readily within the capability of a skilled person to implement the invention for various optical drives and/or carriers.

In a second embodiment, a third asymmetry measurement (As3) is performed. Based on this asymmetry measurement an equalizer Equa of the upper data channel is used for amplifying a data channel portion comprising a relatively low integer of channel bits, e.g. 3T, 4T, 5T, in a channel code such as EFM or EFM+ of the data channel HF in response to the third indication of asymmetry (As3). The settings of the equalizer Equa may be adjusted by changing a gain ratio between a high frequency region and a low frequency region. Optionally, the third asymmetry measurement may include a plurality of asymmetry measurements and the settings of the equalizer Equa may accordingly be assessed on this plurality of asymmetry measurement under an optimization procedure.

In a third embodiment, the settings of the equalizer Equa may be adjusted and the resulting jitter of the binary read signal monitored. Jitter is the standard deviation of the time variation of the binary read signal. This binary read signal is created by a slicer slic, after feeding the HF signal from the HF channel through the equalizer Equa. The jitter of the leading and trailing edges is measured relative to the PLL clock and normalized by the channel bit clock period. In FIG. 4, a representative graph of such a procedure is shown. The graph has the relative jitter on the vertical axis and various settings of the equalizer Equa on the horizontal axis. As it is evident in FIG. 4, the jitter has a minimum around approximately 5.5 of settings of the equalizer Equa, thereby providing the optimum equalizer setting for minimizing the jitter.

After the jitter optimization, the binary read signal is transmitted to the demodulation unit Demod for further decoding and error correction under the appropriate error correction code (ecc).

In the lower channel of the processor 50, signals A . . . D are transmitted to a sum difference circuit +/− for processing of the relevant first signals A . . . D for radial error (RE) tracking, e.g. a push pull signal PP, and a focus error (FE) signal. After amplification at the lower VGA, the FE and RE signals are transmitted to the DSP.

The FE and RE signals are transmitted to the DSP for initial analog to digital conversion in the lower ADC of the DSP, this ADC being a flash ADC outputting a PCM signal. Similarly, peak determination may be applied for controlling the variable gain amplifier VGA of the lower channel in the ASP, thereby optimizing the amplification level of the radial error (RE) signal and focus error (FE) signal. Possibly, just one of the error signals may be amplified. This amplification of the radial error (RE) signal and/or focus error (FE) signal is preferably performed just after the decreasing of the cut-off frequency to a first cut-off frequency (HPF1) of the high pass filtering performed on the data channel HF.

In FIG. 5, a flow-chart of a method according to the present invention is shown. The method comprises the steps of:

S1 initially, settings such as carrier detection, rotation speed, reflection level, radial and focus control loop and various other start up procedures are performed.

S2 determining a first indication/measurement of asymmetry As1? of a data channel HF of the information from the optical carrier 1,

if said first indication of asymmetry is above a pre-defined first threshold then

S3 decreasing an upper cut-off frequency HPF to a first cut-off frequency HPF1 of a high pass filtering BPF performed on the data channel HF of the information on the carrier 1 in response to said first indication of asymmetry As1?.

S4 optimizing an amplification level of a radial error signal RE and/or a focus error signal FE of a servomechanism controlling the optical carrier 1.

S5 determining a second indication/measurement of asymmetry As2? of the data channel HF from the optical carrier 1.

If the second indication of asymmetry As2? is above a pre-defined second threshold then the method continues with S6. If the asymmetry is below the second threshold then the method continues to step S11 (see below).

S6 is the optional step of turning off the limit equalizer to avoid distortion of the high frequency part of the HF signal.

S7 is the step of further decreasing the cut-off frequency to a second cut-off frequency HPF2 of the high pass filtering performed on the data channel HF of the information on the carrier 1 and/or increasing a lower cut-off frequency LPF1 of a low pass filtering performed on the data channel HF of the information on the carrier if said second indication of asymmetry As2? is above a pre-defined second threshold. Thus, steps S7 and S8 in combination may be seen as a narrowing of the frequency window of the band pass filter BPF. Possibly, the second cut-off frequency HPF2 and/or the lower cut-off frequency LPF1 are adjusted as a result of an optimization procedure for the asymmetry As2.

S8 determining a third indication of asymmetry As3? of the data channel HF from the optical carrier, and then S9 applying an equalizer for amplifying a data channel portion comprising a relatively low integer of channel bits (e.g. 3T) in a channel code of the data channel HF in response to said third indication of asymmetry As3?. Thus, the 3T and similar parts are boosted. The equalizer may be equivalently be replaced by a similar electronic device or circuit capable of selectively amplifying a certain frequency domain of the HF signal.

S10 comprises the step of performing an optimization of the data channel jitter by variation of one or more adjustable parameters of the equalizer Equa.

S11 Finally, after the method of the present invention is implemented, the optical drive may continue and prepare for recording/reproducing of information from the carrier 1; e.g. radial capture and initialization may be started.

Although the present invention has been described in connection with the specified embodiments, it is not intended to be limited to the specific form set forth herein. Rather, the scope of the present invention is limited only by the accompanying claims. In the claims, the term comprising does not exclude the presence of other elements or steps. Additionally, although individual features may be included in different claims, these may possibly be advantageously combined, and the inclusion in different claims does not imply that a combination of features is not feasible and/or advantageous. In addition, singular references do not exclude a plurality. Thus, references to “a”, “an”, “first”, “second”, etc. do not preclude a plurality. Furthermore, reference signs in the claims shall not be construed as limiting the scope.

1. A method for improving the playability of information from a non-ideal optical carrier (1) during readout of information from the optical carrier, the method comprising the steps of:
a. determining a first indication of asymmetry (As1) of a data channel (HF) of the information from the optical carrier,
if said first indication of asymmetry is above a pre-defined first threshold then
b. decreasing an upper cut-off frequency (HPF) to a first cut-off frequency (HPF1) of a high pass filtering (BPF) performed on the data channel (HF) of the information on the carrier in response to said first indication of asymmetry (As1),
c. optimizing an amplification level of a radial error signal (RE) and/or a focus error signal (FE) of a servomechanism controlling the optical carrier, and
d. determining a second indication of asymmetry (As2) of the data channel (HF) from the optical carrier.

2. A method according to claim 1 comprising the step of e1) further decreasing the cut-off frequency to a second cut-off frequency (HPF2) of the high pass filtering performed on the data channel (HF) of the information on the carrier if said second indication of asymmetry (As2) is above a pre-defined second threshold.

3. A method according to claim 1 further comprising the step of e2) increasing a lower cut-off frequency (LPF1) of a low pass filtering performed on the data channel (HF) of the information on the carrier if said second indication of asymmetry (As2) is above a pre-defined second threshold.

4. A method according to claim 2, wherein the second cut-off frequency (HPF2) and/or the lower cut-off frequency (LPF1) is/are adjusted as a result of an optimization procedure for the asymmetry (As2).

5. A method according to claim 1 further comprising the steps of f) determining a third indication of asymmetry (As3) of the data channel (HF) from the optical carrier, and then g) applying an equalizer for amplifying a data channel portion comprising a relatively low integer of channel bits (3T) in a channel code (EFM+) of the data channel (HF) in response to said third indication of asymmetry (As3).

6. A method according to claim 5 further comprising the step h) of performing an optimization of the data channel jitter by variation of one or more adjustable parameters of the equalizer (a,b).

7. A method according to claim 5, wherein the said data channel portion comprises the lowest integer number of channel bits (3T) in the channel code (EFM+) of the data channel (HF).

8. A method according to claim 1, wherein the step c) of optimizing an amplification level of a radial error signal (RE) and/or a focus error signal (FE) of a servomechanism controlling the optical carrier is performed by application of automatic gain control (ATC).

9. A method according to claim 1, wherein one or more of the steps a, b, c, and d are repeated a plurality of times.

10. An optical drive for recording/reproducing information from a non-ideal optical carrier (1), said optical drive being adapted to improve the playability during readout of information from the optical carrier, the optical drive comprising:
a. measurement means (As?) adapted for determining a second indication of asymmetry (As2) of the data channel (HF) from the optical carrier. determining a first indication of asymmetry (As1) of a data channel (HF) of the information from the optical carrier,
b. high pass filtering (BPF) means for decreasing an upper cut-off frequency (HPF) to a first cut-off frequency (HPF1) of the data channel (HF) of the information on the carrier in response to said first indication of asymmetry (As1) if said first indication of asymmetry is above a pre-defined first threshold, and
c. amplification means (AGC) for optimizing an amplification level of a radial error signal (RE) and/or a focus error signal (FE) of a servomechanism controlling the optical carrier, and
d. measurement means (As?) adapted for determining a second indication of asymmetry (As2) of the data channel (HF) from the optical carrier.

11. A computer program product being adapted to enable a computer system comprising at least one computer having data storage means associated therewith to improve the playability of information from a non-ideal optical carrier (1) during readout of information according to claim 1.
